(19) United States
(12) Patent Application Publication
(10) Pub. No.: US 2008/0306861 A1
(43) Pub. Date: Dec. 11, 2008

(54) SYSTEM AND METHOD FOR INDEX BASED SETTLEMENT UNDER PRICE PROTECTION CONTRACTS

(75) Inventors: Robert M. Fell, Summerland, CA (US); Scott Painter, Bel Air, CA (US); Michael R. Bonsignore, Seattle, WA (US); Brian P. Reed, Southlake, TX (US); Gary A. Magnuson, Corpus Christi, TX (US)

Correspondence Address: SPRINKLE IP LAW GROUP, 1301 W. 25TH STREET, SUITE 408, AUSTIN, TX, 78705, US

(73) Assignee: Pricelock, Inc., Irving, TX (US)

(21) Appl. No.: 12/099,253

(22) Filed: Apr. 8, 2008

Related U.S. Application Data
(60) Provisional application No. 60/922,427, filed on Apr. 9, 2007.
(60) Provisional application No. 60/922,488, filed on Apr. 9, 2007.
(60) Provisional application No. 60/922,520, filed on Apr. 9, 2007.

(51) Int. Cl. G06Q 40/00

(52) U.S. Cl. 705/37

(57) ABSTRACT

Systems and methods for the provisioning of price protection contracts which provide price protection against adverse fluctuations in the retail price of a commodity are disclosed. While these price protection contracts may pertain to almost any type of commodity, certain embodiments of the present invention may provide systems and method for allowing a consumer to obtain price protection on the purchase of fuel. Specifically, embodiments of the present invention may provide the ability to obtain a price protection contract for the purchase of fuel where the price protection contract specifies at least one lock price, quantity, locale and time period such that the price protection contract may guarantee the right to aggregately purchase the quantity of fuel in the locale at the lock price during the time period and where purchases under the price protection contract are settled against an index price at the time of the purchase.

### RELATED INFORMATION

This application claims a benefit of priority to the filing date of U.S. Provisional Patent Application Ser. No. 60/922,427, by inventors Robert M. Fell, Scott Painter, Brian P. Reed, Michael R. Bonsignore and Gary A. Magnuson, entitled “SYSTEM AND METHOD FOR INDEX BASED SETTLEMENT UNDER PRICE PROTECTION CONTRACTS” filed on Apr. 9, 2007, the entire contents of which are hereby expressly incorporated by reference for all purposes.

### TECHNICAL FIELD

The present invention relates generally to systems and methods for commodity purchasing, and in particular to systems and methods for commodity purchasing which allow consumers to protect against variability in the market for a commodity. Even more particularly, embodiments of the present invention relate to systems and methods for commodity purchasing which allow a consumer to obtain protection against adverse fluctuations in the price of a commodity.

### BACKGROUND

Almost all commodities that consumers purchase fluctuate in price on a regular basis. The periodicity of these fluctuations depends heavily on a variety of factors, including supply and demand, or variables associated with the supply and demand. Certain commodities are more volatile than others, however. These commodities are usually in relatively heavy demand or are widely consumed such that any disruption in the supply of the commodity may cause a commensurate market spike in the prices of these goods. Products of this type include fuel products such as gasoline or diesel, heating oil, natural fuel, crude oil, etc. Disruptions in the supply of these products (or commodities from which these products are produced) such as those caused by worlds events, natural disasters, etc. may cause the price of these commodities to jump markedly in a relatively short amount of time. These price spikes are quite noticeable, as these types of products are extensively consumed and fluctuations in the price of these products may occur relatively rapidly.

The severity of the effects of these price spikes on a given individual or entity is usually tied directly to the amount of the product consumed. Thus, while individual consumers are certainly affected by spikes in the price of a commodity such as gasoline or diesel, these effects may be even more pronounced with regards to large consumers of the commodity. For example, with respect to gasoline or diesel, businesses which rely on a fleet of vehicles to conduct their day to day operations may be severely financially strained by an increase in the price of the commodity. Furthermore, these constant fluctuations in price make anticipating future expenses for the commodity difficult, creating budgeting and accounting issues for these businesses.

Consequently, many individual consumers and businesses desire to financially protect themselves from potential increases in the price of a commodity to not only lower costs for themselves but, additionally, to create greater predictability in future costs for that commodity. There are currently a variety of schemes that allow consumers to purchase commodities, one example of these types of schemes is a fuel card, which is similar to the concept of a gift card. Consumers may purchase a fuel card such that the fuel card has an associated value. Whenever the fuel card is used to purchase fuel at a retail point of sale location, however, the retail price at the time of purchase may be used to subtract value from the fuel card. Thus, the consumer is not protected from adverse fluctuations in the market price of fuel.

Suppose, for example, that a consumer purchases a fuel card with a value of $100 dollars. The consumer may then make a first purchase of 4 gallons of fuel at a time when the retail price of fuel is $2.50, thus for this purchase a value of $10.00 (4 gallons times the $2.50 cost per gallon) is deducted from the value of the fuel card such that amount remaining on the fuel card which may be used to purchase fuel is $90.00. The consumer then makes a second purchase of 4 gallons of fuel at a different time where the retail price of fuel is $3.00. In this case, $12.00 (4 gallons times the $3.00 cost per gallon) is subtracted from the value of the fuel card such that the fuel card may still be used to purchase $78.00 (the $12.00 of the current purchase subtracted from the $90.00 of value remaining on the fuel card) of fuel. As can be seen then, when consumers utilize these schemes they are not protected from fluctuations in the retail price of a commodity as the purchase of the commodities at a particular time occurs at the retail price in effect at that time.

Some purchasing systems have been introduced in certain industry segments in an effort to address this issue. For example, there are certain schemes which allow a consumer to purchase a good or service and take later delivery, in whole or in part, such as purchasing a quantity of fuel which is physically deposited in a storage tank for future at will consumption. In other words the physical product itself has to be ordered and deposited into a storage facility, which has a limited capacity.

These types of systems are cumbersome for a variety of reasons: not only do they require dedicated storage, but additionally, delivery must be taken at the storage location itself. Moreover, the quantity of the commodity purchased has been pre-purchased, thus to utilize this method beneficially may require a preternatural ability to forecast where the market price for the product is going (for example, will it become more or less expensive), estimate a consumption pattern for the commodity and, based upon these forecasts, estimates, current retail price, and myriad other factors, determine how much of the commodity is desired. As may be imagined these types of schemes are a rather impractical way for businesses to protect themselves against price fluctuations in a commodity and may be almost impossible for a consumer to utilize.

To remedy defects of the purchase and delivery systems discussed above, other schemes have been introduced whereby an individual consumer or a business consumer (for example a fleet manager) may purchase a quantity of a commodity (such as fuel) at the then prevailing retail price such that an account associated with the consumer is credited with the amount purchased. At this point, the physical commodity (for example, fuel) has not actually been delivered but a quantity is held on reserve that can be redeemed in part or in whole at a variety of locations. While this type of system allows consumers or business to take delivery of the commodity in smaller quantities at a variety of locations it manifests many of the same problems as the purchase and delivery systems discussed above.

More specifically, while the delivery options have changed (for example, it is now possible to take delivery at many locations in many installments instead of storing the purchase commodity) the purchasing of the commodity remains the same. In other words, in both cases the transaction for the commodity has been consummated; the consumer has made a purchase of a specified quantity of the commodity at a specified retail price.

Consequently, the drawbacks of the purchase and delivery systems discussed above apply equally well here. These systems require the ability to forecast the market for the commodity, estimate a consumption pattern for the good, and based upon these forecasts, estimates, the current retail price, and myriad other factors, determine how much of the commodity is desired.

From a financial perspective these types of systems have an even greater drawback: they only protect a consumer from potential up ticks in the retail price of the commodity. To elucidate, if a consumer purchases a certain quantity of a commodity at a certain retail price and the retail price for that commodity does indeed go up the consumer has saved himself the difference between the retail price at which he purchased and the increased retail price.

Suppose, however, that the consumer is incorrect in predicting that retail prices for the commodity will increase. In this case, the consumer is forced to choose between buying the commodity at the prevailing (lower) retail price and using the pre-purchased commodity (paid for at the previous higher retail price). This places the consumer in an undesirable situation. If the consumer's forecast for a needed quantity of a commodity is correct, the desired amount of the commodity has been pre-purchased and thus, buying the commodity at the prevailing retail price may lead to unused capacity vis-à-vis the commodity. The consumer must choose between saving the margin between the lower prevailing retail price and the pre-purchased price and having unused capacity.

Complicating the issue further, the more volatile the price of the commodity and the larger the volume of the commodity consumed the more complicated these types of calculations become. For example, suppose a fleet manager pre-purchases a quantity of fuel that he anticipates his fleet will utilize for a certain time period at a pre-purchase retail price. Everyday that the prevailing retail price for fuel is below the pre-purchase retail price the fleet manager must determine if it is financially beneficial to purchase fuel at the then prevailing retail price given the amount of fuel the fleet has consumed, the amount of fuel the fleet manager anticipates the fleet will consume, the pre-purchase retail price, the prevailing market price and a whole host of other variables. Many of these variables, however, remain in a constant state of flux. As may be imagined then, the calculations that the fleet manger must make to determine an optimum fuel purchasing strategy grow increasingly more complicated.

Thus, there is a need for systems and methods for commodity purchasing which allow consumers to protect against variability in the price for a commodity by allowing a consumer to obtain price protection against adverse fluctuations in the price of a commodity.

### SUMMARY

Systems and methods for the provisioning of price protection contracts which provide price protection against adverse fluctuations in the retail price of a commodity to a consumer are disclosed. While these price protection contracts may pertain to almost any type of commodity, embodiments of the present invention may provide systems and method for allowing a consumer to obtain price protection on the purchase of fuel. Specifically, embodiments of the present invention may provide the ability for consumers to obtain a price protection contract for the purchase of fuel where the price protection contract specifies at least one lock price, quantity, locale or time period such that if an index price of fuel goes above the lock price in the locale fuel may be purchased at an index price at any of a number of associated retail point of sale locations within the locale, otherwise fuel may be purchased at the then prevailing retail price. Thus, the price protection contract may guarantee for the time period the right to aggregately purchase the quantity of fuel in the locale at the lock price.

Thus, utilizing embodiments of the present invention a consumer may protect himself from adverse fluctuations in the market for fuel for the time period specified by providing a pre-payment for a quantity of fuel at a lock price such that the quantity of fuel may be aggregately purchased using the prepayment amount. Thus, if an index price for fuel should exceed the lock price the consumer may purchase fuel at the lock price. By the same token, however if the index price of fuel falls below the lock price fuel may be purchased by the consumer at the retail price.

The functionalities and processes described herein can be implemented at least in part in suitable computer-executable instructions. The computer-executable instructions may be stored as software code components or modules on one or more computer readable media (for example, non-volatile memories, volatile memories, DASD arrays, magnetic tapes, floppy diskettes, hard drives, optical storage devices, or any other appropriate computer-readable medium or storage device). In one exemplary embodiment of the invention, the computer-executable instructions may include lines of complied C++, Java, HTML, or any other programming or scripting code.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements. Other objects and advantages of the present invention will become apparent to one skilled in the art upon reading and understanding the detailed description of the embodiments described herein and examples thereof.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram illustrating one embodiment of a topology which may be used to implement embodiments of the present invention.

FIG. 2 is a flow diagram for one embodiment of settling a price protection contract using an index.

FIG. 3 is a block diagram of one embodiment of the creation and use of an insurance strike price matrix.

FIG. 4 is a flow diagram for one embodiment of settling a price protection contract using an index.

FIG. 5 is two tables representing examples of settling based on an index.

FIG. 6 is a flow diagram for one embodiment of creating an index.

### DETAILED DESCRIPTION

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. Skilled artisans should understand, however, that the detailed description and the specific examples, while disclosing preferred embodiments of the invention, are given by way of illustration only and not by way of limitation. Various substitutions, modifications, additions or rearrangements within the scope of the underlying inventive concept(s) will become apparent to those skilled in the art after reading this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example”, “for instance”, “e.g.”, “in one embodiment”, etc.

Reference is now made in detail to the exemplary embodiments of the invention, examples of which are illustrated in the accompanying drawings. Wherever possible, the same reference numbers will be used throughout the drawings to refer to the same or like parts (elements).

Within this disclosure, the term “commodity” refers to an article of commerce—an item that can be bought and sold freely on a market. It may be a product which trades on a commodity exchange or spot market and which may fall into one of several categories, including energy, food, grains, and metals. Currently, commodities that can be traded on a commodity exchange include, but are not limited to, crude oil, light crude oil, natural gas, heating oil, gasoline, propane, ethanol, electricity, uranium, lean hogs, pork bellies, live cattle, feeder cattle, wheat, corn, soybeans, oats, rice, cocoa, coffee, cotton, sugar, gold, silver, platinum, copper, lead, zinc, tin, aluminum, titanium, nickel, steel, rubber, wool, polypropylene, and so on. Note that a commodity can refer to tangible things as well as more ephemeral products. Foreign currencies and financial indexes are examples of the latter. For example, positions in the Goldman Sachs Commodity Index (GSCI) and the Reuters Jefferies Consumer Research Board Index (RJCRB Index) can be traded as a commodity. What matters is that something be exchanged for the thing. New York Mercantile Exchange (NYMEX) and Chicago Mercantile Exchange (CME) are examples of a commodity exchange. Other commodities exchanges also exist and are known to those skilled in the art.

In a simplified sense, commodities are goods or products with relative homogeneousness that have value and that are produced in large quantities by many different producers; the goods or products from each different producer are considered equivalent. Commoditization occurs as a goods or products market loses differentiation across its supply base. As such, items that used to carry premium margins for market participants have become commodities, of which crude oil is an example. However, a commodity generally has a definable quality or meets a standard so that all parties trading in the market will know what is being traded. In the case of crude oil, each of the hundreds of grades of fuel oil may be defined. For example, West Texas Intermediate (WTI), North Sea Brent Crude, etc. refer to grades of crude oil that meet selected standards such as sulfur content, specific gravity, etc., so that all parties involved in trading crude oil know the qualities of the crude oil being traded. Motor fuels such as gasoline represent examples of energy-related commodities that may meet standardized definitions. Thus, gasoline with an octane grade of 87 may be a commodity and gasoline with an octane grade of 93 may also be a commodity, and they may demand different prices because the two are not identical—even though they may be related. Those skilled in the art will appreciate that other commodities may have other ways to define a quality. Other energy-related commodities that may have a definable quality or that meet a standard include, but are not limited to, diesel fuel, heating oils, aviation fuel, and emission credits. Diesel fuels may generally be classified according to seven grades based in part on sulfur content, emission credits may be classified based on sulfur or carbon content, etc.

Historically, risk is the reason exchange trading of commodities began. For example, because a farmer does not know what the selling price will be for his crop, he risks the margin between the cost of producing the crop and the price he achieves. In some cases, investors can buy or sell commodities in bulk through futures contracts. The price of a commodity is subject to supply and demand.

A commodity may refer to a retail commodity that can be purchased by a consuming public and not necessarily the wholesale market only. One skilled in the art will recognize that embodiments disclosed herein may provide means and mechanisms through which commodities that currently can only be traded on the wholesale level may be made available to retail level for retail consumption by the public. One way to achieve this is to bring technologies that were once the private reserves of the major trading houses and global energy firms down to the consumer level and provide tools that are applicable and useful to the retail consumer so they can mitigate and/or manage their measurable risks involved in buying/selling their commodities. One example of an energy related retail commodity is motor fuels, which may include various grades of gasoline. For example, motor fuels may include 87 octane grade gasoline, 93 octane grade gasoline, etc as well as various grades of diesel fuels. Other examples of an energy related retail commodity could be jet fuel, heating oils, electricity or emission credits such as carbon offsets. Other retail commodities are possible and/or anticipated.

While a retail commodity and a wholesale commodity may refer to the same underlying good, they are associated with risks that can be measured and handled differently. One reason is that, while wholesale commodities generally involve sales of large quantities, retail commodities may involve much smaller transaction volumes and relate much more closely to how and where a good is consumed. The risks associated with a retail commodity therefore may be affected by local supply and demand and perhaps different factors. Within the context of this disclosure, there is a definable relationship between a retail commodity and the exposure of risks to the consumer. This retail level of the exposure of risks may correlate to the size and the specificity of the transaction in which the retail commodity is traded. Other factors may include the granularity of the geographic market where the transaction takes place, and so on. For example, the demand for heating oil No. 2 in January may be significantly different in the Boston market than in the Miami market.

No matter, what the commodity, however, in many instances individual consumers and businesses desire to financially protect themselves from potential increases in the price of a commodity to not only lower costs for themselves but, additionally, to create greater predictability in future costs for that commodity. For example, as the price of oil continues to fluctuate globally and fluidly, fuel prices at the pump can change from location to location on a daily or even hourly basis. In such a volatile market, a consumer or business may desire to protect themselves against adverse fluctuations.

Before discussing particular embodiments of the present invention it may be useful to explain in more detail embodiments of systems and methods for the provisioning of price protection contracts which provide price protection against adverse fluctuations in the price of a commodity to a consumer are disclosed. While these price protection contracts may pertain to almost any type of commodity (as discussed above), embodiments of the present invention may provide systems and method for allowing a consumer to obtain price protection on the purchase of fuel. Specifically, embodiments of the present invention may provide the ability for consumers to obtain a price protection contract for the purchase of fuel where the price protection contract specifies at least one lock price, quantity, locale or time period such that if an index price of fuel goes above the lock price in the locale fuel may be purchased at the lock price at any of a number of associated retail point of sale locations within the locale, otherwise fuel may be purchased at the then prevailing retail price. Thus, the price protection contract may guarantee for the time period the right to aggregately purchase the quantity of fuel in the locale at the lock price.

Other objects and advantages of the present invention will become apparent to one skilled in the art upon reading and understanding the detailed description of the preferred embodiments described herein and examples thereof found in application Ser. No. 11/705,571 by inventors Robert M. Fell, Scott Painter, Michael R. Bonsignore, Brian P. Reed, and Gary A. Magnuson, titled: “METHOD AND SYSTEM FOR PROVIDING PRICE PROTECTION FOR COMMODITY PURCHASING THROUGH PRICE PROTECTION CONTRACTS,” and filed on Feb. 12, 2007 while examples of revenue models for generating revenue from the provisioning of these price protection contracts can be found in application Ser. No. 12/030,073 by inventors Robert M. Fell, Scott Painter, Michael R. Bonsignore, Brian P. Reed, Gary A. Magnuson, and Thomas D. Gros, entitled “SYSTEM AND METHOD FOR GENERATING REVENUES IN A RETAIL COMMODITY NETWORK” and filed on Feb. 12, 2008, all of which are fully incorporated herein by reference.

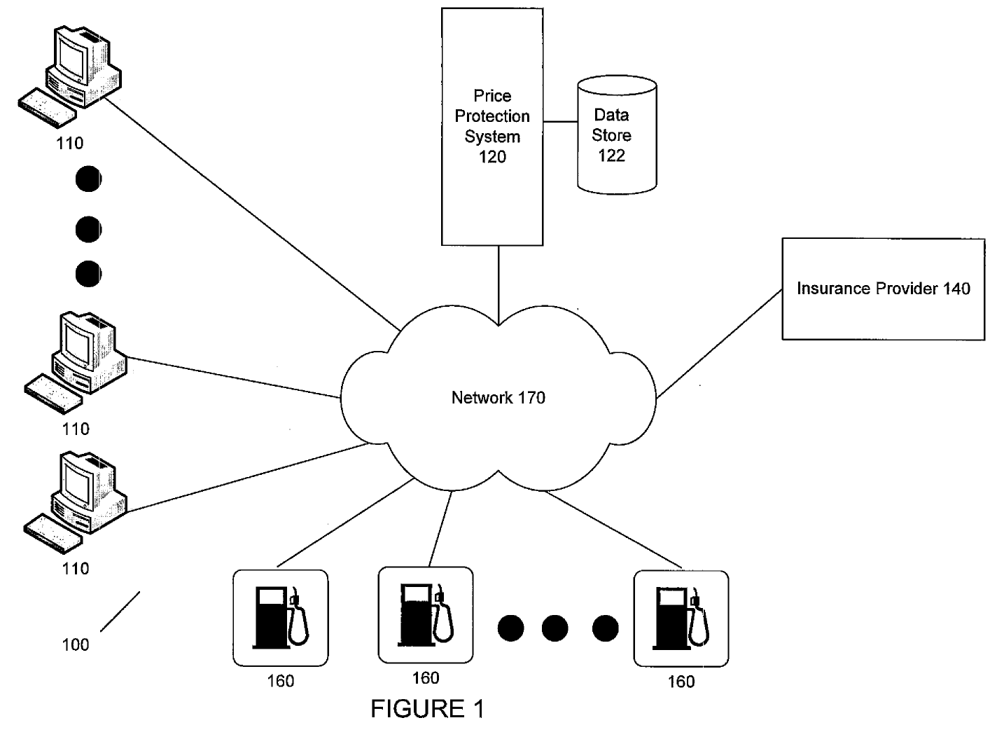

Embodiments of the systems and methods of the present invention may be better explained with reference to FIG. 1 which depicts one embodiment of a topology which may be used in conjunction with the systems and methods of the present invention. Topology 100 comprises price protection system 120 which is coupled through network 170 to computing devices 110 (for example, computer systems, personal data assistants, kiosks, dedicated terminals, etc), insurance provider 140, and one or more associated retail point of sale locations 160.

Insurance provider 140 may provide an insurance strike price and an associated insurance cost (for example, hedge cost per gallon or HCPG) for a locale (for example, a DMA, zip code, county, etc.), such that by paying the insurance cost to the insurance provider the payer will be indemnified for any cost of fuel above the insurance strike price. Price protection system 120 may utilize the insurance strike price and associated insurance cost to provision price protection contracts to various consumers.

More particularly, fleet managers (or any other consumer) desiring to obtain protection from future increases in the retail price of fuel, or to increase predictability of future fuel costs, may access price protection system 120 to obtain price protection contracts pertaining to fuel. More specifically, in one embodiment, a fleet manager may access price protection system 120 on computing device 110 using a set of interfaces provided by price protection system 120 in order to provide a set of inputs regarding desired price protection to price protection system 120. Using these inputs, price protection system 120 may utilize an insurance strike price and an associated insurance cost provided by insurance provider 140 to determine a price protection contract.

Using the insurance strike price obtained from insurance provider 140 then, price protection system 120 may present the fleet manager with a price protection contract specifying at least one lock price, quantity, locale, fuel grade or time period, which the fleet manager can obtain it he desires. By obtaining this price protection contract the fleet manager guarantees the right to purchase the quantity of the specified grade of fuel at the lock price at a number of retail point of sale locations 160.

If the consumer purchases fuel under the price protection contract when the retail price of the fuel is above the lock price the operators of price protection system 120 may then pay the retail point of sale location for the purchased quantity at the prevailing retail price, or some lesser or greater amount. For the quantity of fuel purchased then, the operators of price protection system 120 may recoup the difference between an insurance strike price and the prevailing retail price at the retail point of sale location at the time of purchase from insurance provider 140.

As the retail price of fuel may fluctuate a great deal even within a given locale, there may be unaccounted for risk introduced by these various price fluctuations with a locale specified by a price protection contract. For example, suppose that a price protection contract specifies a particular locale and lock price and that on a particular day the price at every retail point of sale location in the locale is above the lock price operators, however at one point of sale retail location in the locale the retail price is 0.5 cents above the lock price and at another retail point of sale location in the locale the retail price is 0.25 cents above the lock price. Thus, while the consumer may purchase at the lock price irrespective of the point of sale retail location where he chooses to purchase fuel, for every gallon of fuel purchased insurance provider 140 may need to reimburse operators of price protection system 120 0.5 cents or 0.25 cents depending on the point of sale retail location chosen by the consumer. The problem of moral hazard on the part of the consumer thus arises for insurance provider 140 and operators of price protection system 120, as one or both of them must absorb the difference in cost between the retail price at which the fuel is purchased and the lock price of the price protection contract while the consumer is provided no incentive to purchase fuel at the retail point of sale location with the lowest retail fuel price. Thus, it would be desirable to remove at least a portion of the additional risk caused by the discrepancy between retail prices at various retail point of sale locations and to incentivize a consumer to purchase fuel to a retail point of sale location with the lowest retail price.

To that end, attention is now directed to systems and methods for providing price protection contract to consumers, where purchases under the price protection contract may be settled against an index price. More specifically, embodiments of the present invention may provide a contract for price protection which may protect a consumer against adverse fluctuations while still allowing the consumer to take advantage of any beneficial fluctuations that occur in the market price.

Such a price protection contract may allow a consumer to purchase fuel at a lock price if an index price of fuel at the time of purchase is above the lock price while still allowing a consumer to purchase fuel at the prevailing retail price if the index price, or the prevailing retail price, of fuel at the time of purchase is below the lock price. In other words, if the index price or prevailing retail price of fuel at the time of the purchase is below the lock price the consumer may purchase the fuel at the then prevailing retail price and the cost of the purchase paid via some alternate payment method, such as a credit card.

If, however, the index price of fuel at the time of a purchase is above the lock price associated with the price protection contract fuel may be purchased at the lock price by the consumer. The costs associated with the purchase transaction are then settled with respect to the index price. If the retail price at the retail point of sale location is above the index price at the time of purchase the consumer (or someone else) may be responsible for any difference between the prevailing retail price at the point of sale retail location where the fuel was purchased and the index price (for example, the consumer may be protected for any difference between the lock price and the index price and be responsible for any difference between the retail price and the index price) while if the prevailing retail price at the point of sale retail location where the fuel was purchased is below the index price at the time of purchase the difference between the prevailing retail price and the index price may accrue to the benefit of the consumer, the operators of price protection system 120, both, or some other entity altogether.

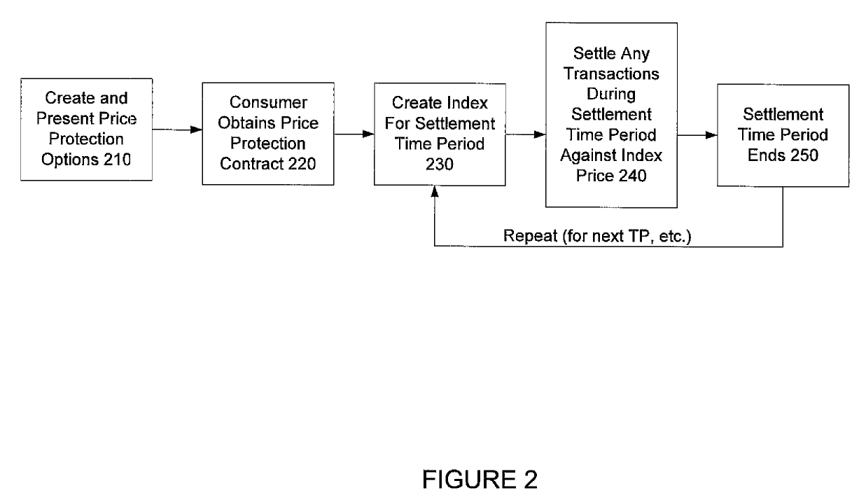

Turning to FIG. 2, one embodiment a method for the provisioning of a price protection contract where purchases under the price protection contract are settled against an index price is depicted. At step 210 price protection system 120 may present a consumer with the ability to obtain a price protection contract. More specifically, in one embodiment price protection system 120 may present a consumer with at least one lock price, fuel grade and time period for each of a set of locales along with purchase price, such that by paying the purchase price for the quantity of fuel desired the consumer may obtain the right to purchase the quantity of the specified grade of fuel at the lock price at a number of retail point of sale locations 160 provided that the fuel is purchased in the specified locale. For example, price protection system 120 may present a consumer with a lock price of $2.50 per gallon for regular gas for 6 months in the Austin DMA where the purchase price for this price protection contract is $2.75 per gallon. In other words, by paying $275.00 a consumer may obtain the right to purchase 100 gallons of gas at $2.50 per gallon in the Austin DMA for the next 6 months.

Once a price protection contract is obtained by the consumer at step 220, price protection system 120 establishes a virtual reserve corresponding to the lock price and quantity of the price protection contract. For a given settlement time period then, an index price may be created at step 230 (for example, an index price may be created for each DMA for which price protection is offered by price protection system 120 for the settlement time period). The settlement time period may be for any granularity of time desired, hourly, daily, weekly, etc. and the creation of this index price may be based upon almost any source desired. For example, it may be a 3^{rd} party index, published by a government entity, and may be provided for instance, by the Department of Energy or the American Automobile Association (AAA), etc., it may be determined by insurance provider 140, operators of price protection system 120, etc. and may be determined based upon almost any methodology, for example using a weighted average of the spotted or transactional gas prices in the DMA, etc. Examples of the gathering and use of such information will be better understood with reference to U.S. application Ser. No. 12/030,119 by inventors Robert M. Fell, Scott Painter, Michael R. Bonsignore, Brian P. Reed and Gary A. Magnuson, entitled “System and Method of Determining a Retail Commodity Price within a Geographic Boundary”, filed on Feb. 12, 2008, fully incorporated herein by reference. Other indices (for example, city and state indices, proprietary indices, national indices, global indices, etc.) can also be utilized or combined to generate a custom index. The creation of such an index will be discussed in more detail later in this disclosure.

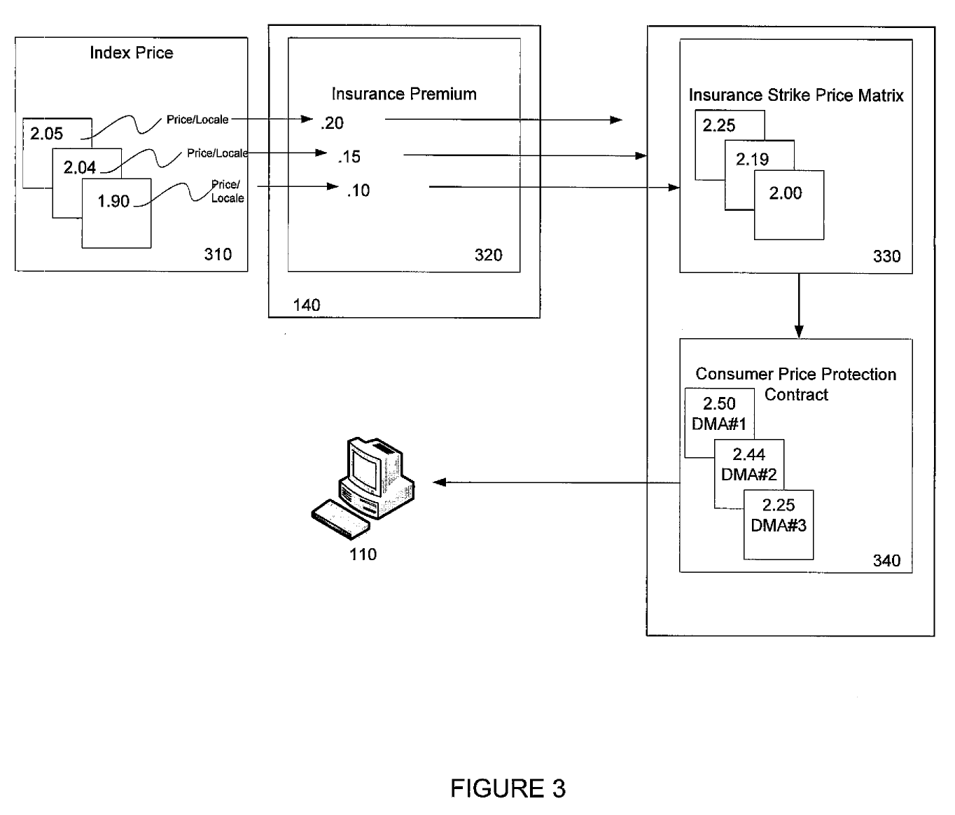

In one embodiment, an index price for the DMA for the particular settlement time period when a consumer is being presented with price protection options may be utilized as the lock price being presented to the consumer in association with the provisioning of a price protection contract during that particular settlement time period. This may be illustrated more clearly with respect to FIG. 3, which depicts one embodiment of the provisioning of price protection. A set of index prices 310 (for example, an index price associated with each of a set of DMAs) may be provided to insurance provider 140 and these index prices 310 used by insurance provider 140 to determine a insurance provider strike price matrix 330, such that the insurance provider strike price matrix 330 comprises DMAs associated with the index price for the DMA and a hedge cost per gallon (HCPG), where by paying the HCPG operators of price protection system 120 may be indemnified for the price of fuel above that index price in the associated DMA.

Using this insurance provider strike price deck 330, price protection system 120 may determine and present to a consumer an option for a price protection contract where the lock price for the price protection may be the index price and the purchase price for the price protection contract may or may not be determined based on the index price (which, for example, may be the index price plus the HCPG plus a profit margin added by operators of price protection system 120, etc.). Thus, as can be seen, the same index price may be associated with a HCPG by insurance provider 140 to provide an insurance provider strike price matrix and utilized by price protection system 120 to offer a price protection to a consumer.

To illustrate numerically, suppose during a certain settlement time period that an index price for the Austin DMA is $2.50 per gallon. This index price may be provided to insurance provider 140 which determines that the HCPG for the Austin DMA for 6 months should be 0.25. This information (for example, that for a cost of 0.25 cents per gallon insurance provider 140 will indemnify against retail prices above $2.50 in the Austin DMA for 6 months) may be used by price protection system to determine a price protection contract where by paying $3.00 a gallon a consumer may obtain the right to purchase fuel at $2.50 per gallon for 6 months in the Austin DMA. Thus, notice that in one embodiment an index price may be associated with a HCPG by insurance provider 140 and presented as a lock price in a price protection contract offered by price protection system 120 to a consumer.

Returning to FIG. 2, when a fuel purchase is made during the settlement time period by a consumer who has a price protection contract, this transaction may be settled with respect to the current index price (for example, the index price calculated for the settlement time period) for that DMA at step 240. At the end of the time period at step 250 then a new index price may be calculated for the next settlement time period at step 230. Once again, it will be realized after reading the above that, in one embodiment, the index price for a particular settlement time period may therefore be used as the lock price for offering price protection to a consumer and as an index price for settling a transaction with a consumer for a price protection contract obtained in a previous time period.

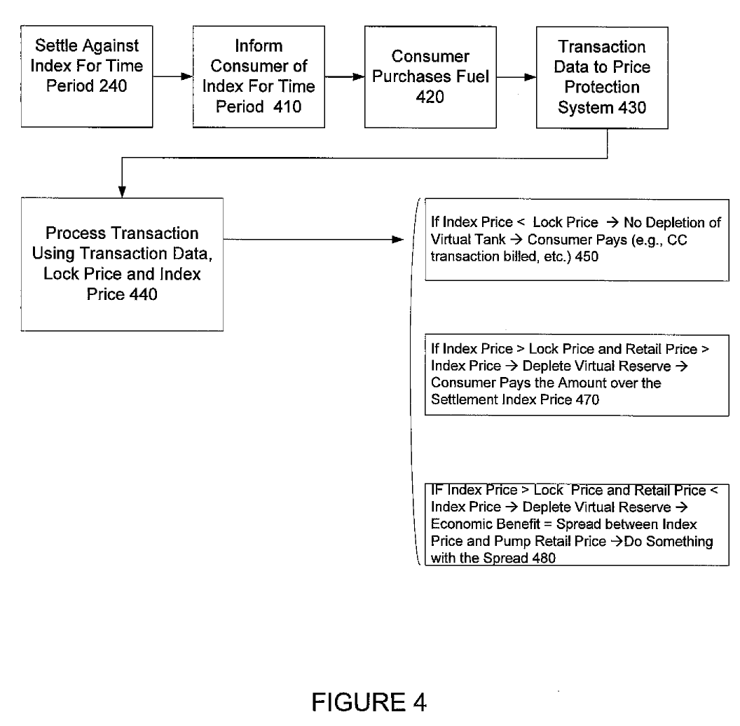

One embodiment of a method for settling transactions under a price protection contract using an index price is depicted in FIG. 4. At step 410 a consumer may be informed of the index price for the settlement time period (for example, the index price for each of the DMAs in which a consumer has obtained price protection). This notification may take place via a number of methodologies, including communicating the index price through a computing device 110 via an interface provided by price protection system 120, sending the index price via mobile communications technology, such as a mobile phone or in car communication system, etc.

Thereafter, during that time period when a consumer purchases fuel at step 420, the transaction data is sent to price protection system 120 at step 430. The transaction data may include consumer identification such that a consumer may be associated with a virtual reserve and pricing data concerning the retail price of fuel at the retail point of sale location where the fuel was purchased and the amount of fuel purchased. The transaction may then be processed using the transaction data at step 440.

Specifically, in one embodiment, if the index price for the settlement time period in which fuel is purchased is less than the lock price associated with the price protection contract obtained by the consumer the consumer may pay for the fuel via some other methodology (for example, such as a credit card associated with the consumer's account) and the consumer's virtual reserve (for example, associated with the price protection contract) is not depleted at step 450. Note with respect to the case where the index price is less than the lock price (step 450) that the consumer may pay for the fuel even if the retail price of the fuel purchased is greater than the lock price associated with the price protection contract obtained by the consumer.

If the index price for the settlement time period in which fuel is purchased is equal to the lock price, the virtual reserve of the consumer may be depleted according to the amount of fuel (or aggregate cost) of the fuel purchased and the operators of price protection system 120 will pay the retail point of sale location for the fuel purchased. Alternatively, the virtual reserve of the consumer may not be depleted and the consumer may pay the retail point of sale location for the fuel purchased. The consumer may also pay via some other methodology altogether (for example cash) and the consumer's virtual reserve will not be depleted.

If, however, the index price for the settlement time period in which fuel is purchased is greater than the lock price associated with the price protection contract obtained by the consumer the virtual reserve of the consumer may be depleted according to the amount of fuel (or aggregate cost) of the fuel purchased and the operators of price protection system 120 will pay the retail point of sale location for the fuel purchased at step 470. Additionally at step 470, if the retail price of fuel at the retail point of sale location is greater than the index price for the settlement time period in which fuel is purchased the consumer may be responsible for the difference between the retail price at the retail point of sale location and the index price. This difference (for example, for the amount of fuel purchased) may be accounted for in a variety of ways. For example, the amount may be deducted from the consumer's virtual reserve, may be charged through to a credit card associated with the consumer's account, the consumer may be sent a bill for the difference, etc. To illustrate numerically, suppose that the lock price for the consumer's price protection contract is $2.50, the index price on the day of the consumer's fuel purchase is $2.75, the retail price at the retail point of sale location where the consumer purchases fuel is $3.00 and the consumer purchases 10 gallons of fuel. In this case, 10 gallons would be depleted from the consumer's virtual reserve, the operators of price protection system 120 would pay the retail point of sale location $30.00 (for example, 10 gallons at $3.00 a gallon) and the consumer would be responsible for $2.50 of the fuel cost (for example, difference between the $3.00 per gallon retail price and the $2.75 per gallon index price for 10 gallons of fuel).

If, on the other hand, the index price for the settlement time period in which fuel is purchased is greater than the lock price associated with the price protection contract obtained by the consumer the virtual reserve of the consumer may be depleted according to the amount of fuel (or aggregate cost) of the fuel purchased and the operators of price protection system 120 will pay the retail point of sale location for the fuel purchased at step 480. Additionally at step 480, if the retail price of fuel at the retail point of sale location is less than the index price for the settlement time period in which fuel is purchased there may be a price differential (referred to as a spread) between the index price and the retail price.

This spread may be kept by operators of price protection system 120, given to the consumer, split between the two or disposed of in some other manner. For example, this spread may be credited to the consumer's virtual reserve or the consumer's account, etc. To illustrate numerically, suppose that the lock price for the consumer's price protection contract is $2.50, the index price on the day of the consumer's fuel purchase is $3.00, the retail price at the retail point of sale location where the consumer purchases fuel is $2.75 and the consumer purchases 10 gallons of fuel. In this case, 10 gallons would be depleted from the consumer's virtual reserve, the operators of price protection system 120 would pay the retail point of sale location $27.50 (for example, 10 gallons at $2.75 a gallon) and $2.50 (for example, the spread between the $2.75 per gallon retail price and the $3.00 per gallon index price for 10 gallons of fuel) may be refunded back to the consumer (or split between operators of price protection system 120 and the consumer, kept entirely by operators of price protection system 120, etc.).

It may be useful here to present some numerical examples of embodiments of the systems and methods of the present invention. It will be understood that these are exemplary only. By way of example, suppose a customer purchases a price protection contract with 100 gallons of gasoline on Day One at a lock price of $2.48 per gallon per the terms of the price protection contract. This price protection contract transaction can take place in many ways through various channels (for example, via a Website, an online store, a brick-and-mortar location, a sales agent, etc.). According to one embodiment, the customer now has a virtual reserve of 100 gallons of gasoline. Suppose also that the index price on Day One is $2.38 and the retail price on Day One is $2.42. One embodiment of the invention enables the customer to select or otherwise set at least one “exercise price” over a period of time (for example, the lock price plus a price tolerance).

When the defined index goes above the exercise price, the customer's virtual tank is depleted by the same amount of the fuel purchased at a retail point of sale location (for example, at the pump). The exercise price is optional and provides the customer with additional flexibility in managing the depletion of the virtual tank. For example, the customer may decide not to exercise right away and sets the exercise price at $2.58, 20 cents above the index price on Day One. So long as the index price is lower than the exercise price, the virtual tank is not depleted when the customer purchases gas.

Suppose now that one month later, the index price moves up to $2.45 and the retail price to $2.48. The virtual tank is still not depleted when the customer purchases gas as the index price of $2.45 is less than the exercise price of $2.58. Suppose two months later, the index price moves up to $2.50 and the retail price to $2.58. The virtual tank is still not depleted when the customer purchases gas as the index price of $2.50 remains less than the exercise price of $2.58.

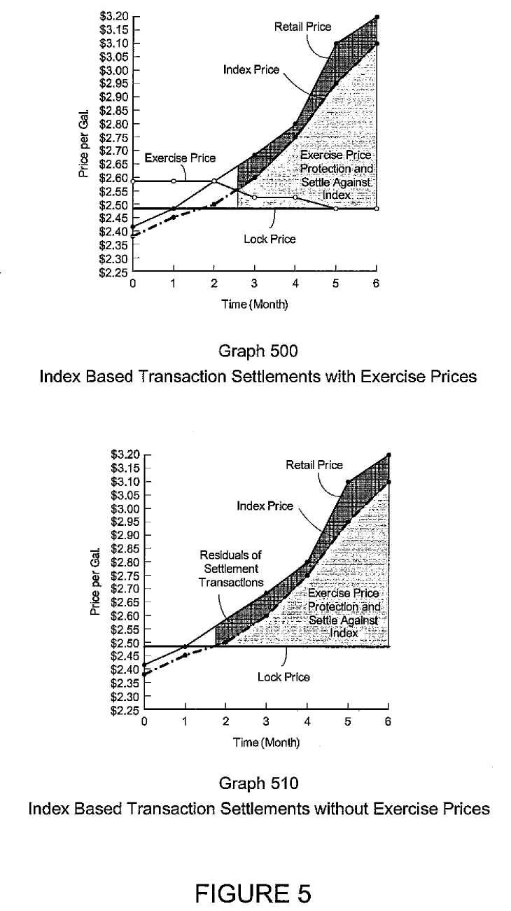

Suppose further that three months later the index price moves up to $2.60 and the retail price to $2.68. At this point the index price of $2.60 exceeds the exercise price of $2.53. Thus, when the customer purchases gas at the pump, the transaction is settled against the index price and his virtual tank is depleted by the amount of fuel purchased. The customer can modify the exercise price at any time or choose not to have an exercise price, in which case, the customer's virtual tank may be depleted whenever the retail price is above the lock price (i.e., the lock price is the default exercise price). Graphs 500 and 510 of FIG. 5 are plot diagrams illustrating how price protection contract transactions are settled with the customer against an exemplary index with and without exercise prices. Note that the time periods (for example, Month 1, Month 2, etc.) of graphs 500 and 510 are meant to be exemplary and by no means limiting.

Table 1 below provides additional details in illustrating how settlements can be triggered based on a comparison between a defined index and an exercise price. As one of ordinary skill in the art can appreciate, the dollar amounts listed in Table 1 are meant to be exemplary only. Note in Table 1, the exemplary retail prices are above the lock price (i.e., the index price at the time of purchase of the price protection contract) and the delivery indices (i.e., the delivery indices on Month 1, Month 2, etc.). Other scenarios are also possible. For example, actual retail prices may go above or below the defined index.

TABLE 1

| | Day 1 | Month 1 | Month 2 | Month 3 | Month 4 | Month 5 | Month 6 | |
|---|---|---|---|---|---|---|---|---|
| Defined Index | $2.38 | $2.45 | $2.50 | $2.60 | $2.75 | $2.95 | $3.10 | |
| Retail Price at Pump | $2.42 | $2.48 | $2.58 | $2.68 | $2.80 | $3.10 | $3.20 | |
| Lock Price | $2.48 | $2.48 | $2.48 | $2.48 | $2.48 | $2.48 | $2.48 | |
| Exercise Price | $2.58 | $2.58 | $2.58 | $2.53 | $2.53 | $2.48 | $2.48 | |
| Exercise? | | NO | NO | YES | YES | YES | YES | |
| Hedge Cost per Gallon | $0.36 | | | | | | | |
| to Insurance Provider | | | | | | | | |
| # Gallons Prepaid | 100 | | | | | | | |
| Total Prepayment | $284.00 | | | | | | | |
| Value of Virtual Tank | $248.00 | | | | | | | |
| | | | | | | | | TOTAL |
| Gallons Filled Up At Pump | | 15 | 17 | 15 | 20 | 25 | 40 | 132 |
| Virtual Tank Gallons Depletion | | 0 | 0 | 15 | 20 | 25 | 40 | 100 |
| Virtual Tank $$ Depletion | | $0.00 | $0.00 | $37.20 | $49.60 | $62.00 | $99.20 | $248.00 |
| Payment to POS Retail Location | | $0.00 | $0.00 | $39.00 | $55.00 | $73.75 | $124.00 | $291.75 |
| Basis Risk Paid by Consumer | | | $1.20 | $1.00 | $3.75 | $4.00 | $9.95 | |
| Benefit of Lower Price to Consumer | | $0.00 | $0.00 | $0.00 | $0.00 | $0.00 | $0.00 | $0.00 |
| Insurance Provider Payment to Operator | | $0.00 | $0.00 | $1.80 | $5.40 | $11.75 | $24.80 | $43.75 |
| of Price Protection System | | | | | | | | |
| Rebate to Customer | | $0.00 | $0.00 | $0.00 | $0.00 | $0.00 | $0.00 | $0.00 |
| (Spread from Index to Retail) | | | | | | | | |

| | |
|---|---|
| Total Cost to Consumer with PRICE | $293.95 |
| PROTECTION CONTRACT (Exercise) | |
| Total Cost to Consumer with PRICE | $301.70 |
| PROTECTION CONTRACT (No Exercise) | |
| Total Cost to Consumer without PRICE | $382.76 |
| PROTECTION CONTRACT | |

As Table 1 illustrates, in settling against a defined index, a consumer may take some of the basis risk. As an example, when the consumer purchases 15 gallons of gas in Month 3, the index price of $2.60 is higher than the exercise price of $2.53. Thus, the consumer's virtual tank is depleted by 15 gallons and the account balance is reduced by $37.20 (lock price $2.48*15 gallons). In this example, the operators of price protection system 120 may pay the retail point of sale $39.00 (index price $2.60*15 gallons). This is referred to as settling against the index. According to the terms of this example price protection contract, the consumer is responsible for the difference between the retail price and the index price at the time of purchase, which, in this case, is $1.20 for 15 gallons or $0.08 per gallon. This is referred to as the residuals of settlement transactions in Graphs 1 and 2. That is, the price protection contract provides price protection up to the index price and the consumer takes some basis risk when purchasing gas at retail prices above the defined index.

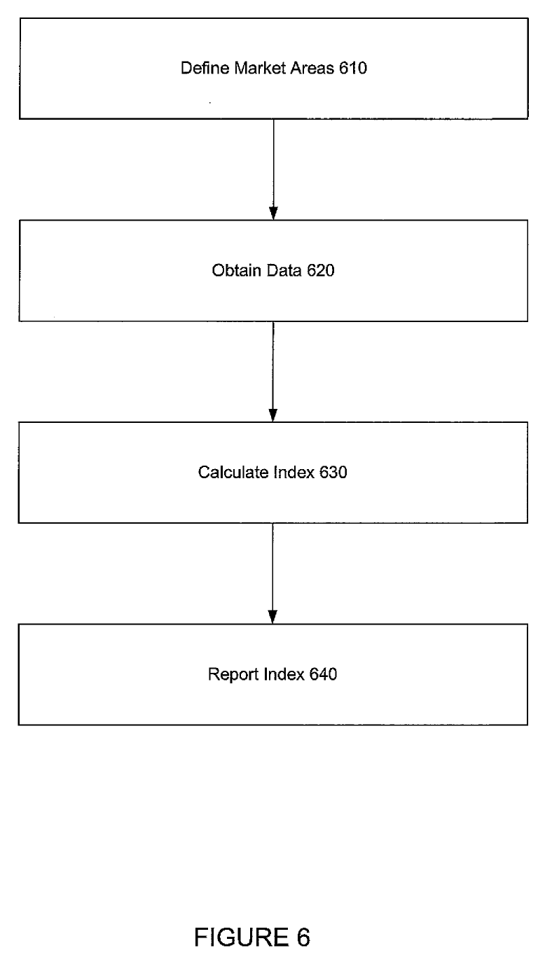

It may be helpful here, to illustrate in more detail how such an index is created. While market indices have existed for more than a century there are unique aspects of fuels that must be addressed in the creation of any pertinent including but not limited to aspects of physical delivery, geographic diversification, and accounting standards compliance. FIG. 6 depicts a flow diagram for one embodiment of a method for creating an index of fuel prices where the index has a set of market areas and corresponding index prices. At step 610 one or more geographic regions for which the index is to be created may be defined. This may be difficult as there may be two aspects to the definition of market area, in general, the consumer aspect and the provider or price protection contracts or insurance. It also may be desirable to have the definition of market area driven by “usefulness.” That is, a consumer of motor fuel in, say, Cleveland, must feel that the Cleveland market area is representative of her risk. “Usefulness” must also relate directly to FASB 133 compliance—that is, the region is granular enough that a hedge placed to mitigate exposure within the region has a sufficient statistical correlation to the price of fuel consumed in that region. It may also be desirable that the market area be big enough to hold the promise of liquidity, or the ability to trade in and out of a risk position. Liquidity allows management of risk. A lack of liquidity implies that the cost of protection would be much higher, likely creating an insurmountable sales impediment for an index.

In one embodiment, in defining market areas a number of regional definitions may be used including the US government's Metropolitan Statistical Areas (MSA's) and the so called “NFL cities,” a definition widely used by the telecommunications industry. Importantly, the region chosen should be wholly within a single tax regime (for example, Baltimore and Washington, D.C. should not be combined to a single region). The actual selection of cities for which indices are initially posted may be partially based on those requested by lead users of an index. This should be balanced against the total number and geographic spread of cities that traders would find useful in an illiquid, start-up risk portfolio. This is the number that allows the unique, city-specific variations to (largely) cancel each other out, making a wholesale trading instrument (such as the NYMEX New York Harbor RBOB contract) useful as a portfolio risk mitigant. With these points in mind, in one embodiments at step 610 between 12 and 20 market areas may be defined.

After the market areas are defined, at step 620 data to be used in creating the index may be obtained. It is desirable that market indices be based on accurate, auditable, consistent data that reflect actual transactions free from manipulation: For example, in one embodiment the data may be: accurate—the obtained data should be correct, counted only once, and include at a minimum a specific time period, quality, price and volume; auditable—a reliable audit chain where any errors can be found and corrected; use actual transactions—whenever possible actual prices agreed by both buyers and sellers will be utilized (in cases where the market is relatively illiquid, it may be necessary to post offers or bids, but then these should be marked as such); free from manipulation—if the market is subject to manipulation, such as having only one supplier, then any generated index should be clearly labeled to indicate that it may not be a reflection of a true market.

In most cases then, the data obtained at step 62 will be actual data obtained from executed transactions and may be obtained, for example, from one or more credit card providers, spotted or reported transactions or the like. However, retail price, even with a market area may vary markedly. For instance, on any given day within the city of Los Angeles, the same brand and octane level of gasoline can vary by as much as $0.60 per gallon. Thus, on one embodiment, obtaining data for use in the creation of indices at step 620 may also comprise processing obtained data for a variety of purposes, including identifying or removing statistical outliers, etc. In one embodiment, however, every auditable transaction should be included in an index calculation with no rounding or no elimination of extreme highs or lows.

Once data to be used in the creation of an index is obtained the index itself may be calculated at step 630. A variety of types of calculations may be utilized to create the index. The calculations may, for example, volume-weight transactions (for example, obtained data) when calculating the index, define a minimum purchase volume necessary for a transaction to be included in the market index, etc. In one embodiment a daily index is calculated using a simple weighted average of all transactions recorded during the calendar day, midnight to midnight in a corresponding market area, displaying five significant digits (one digit more than shown on typical pump display) using the equation: INDEX_{City X}={(Price₁×Volume₁)+(Price₂×Volume₂ . . . )}/{Volume₁+Volume₂+ . . . }. In one embodiment, a monthly index may be calculated using a similar volume weighting to ensure that a low-volume weekend day does not have the same weight as a high-volume business day.

Once the index is calculated it may then be reported at step 640. This reporting may comprise not only the set of market areas and corresponding index prices but other data as well. For example, the high price, low price, total volume and number of transactions included in calculation may be explicitly reported. By reporting this information an objective level of the credibility and liquidity in the index is provided along with a useful measure of risk and relative liquidity across cities. Additionally, data, such as non-transaction based data, which may or may not have been used in the calculation of the index but also be reported, etc.

In the foregoing specification, the invention has been described with reference to specific embodiments. However, one of ordinary skill in the art will appreciate that various modifications and changes can be made without departing from the spirit and scope of the invention disclosed herein. Accordingly, the specification and figures disclosed herein are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for providing price protection for commodity purchasing, comprising:
obtaining data regarding desired price protection from a consumer; and
providing a financial instrument for a commodity to the consumer where the financial instrument has an associated quantity, time period, lock price and locale wherein for a set of purchases occurring in the locale during the time period the consumer has a right to aggregately purchase the quantity of the commodity wherein for each purchase the commodity may be purchased at the lock price if a first index price associated with the commodity at a first time of the purchase is above the lock price or at a retail price of the commodity otherwise.

2. The method of claim 1, wherein if the index price is greater than the lock price and the retail price is greater than the first index price the consumer pays the difference between the lock price and the retail price.

3. The method of claim 1, wherein if the first index price is greater than the lock price and the retail price is less than the first index price the consumer receives at a least a portion of a spread between the retail price and the first index price.

4. The method of claim 1, wherein the first index price corresponds to the locale.

5. The method of claim 4, further comprising determining the lock price.

6. The method of claim 5, wherein determining the lock price comprises determining a second index price associated with the locale at a second time when the financial instrument is provided and using the second index price to determine the second index price.

7. The method of claim 6, wherein determining the lock price comprises:
receiving an insurance strike price matrix; and
determining the lock price based on the insurance strike price matrix, the locale, the time period and the fuel grade.

8. The method of claim 7, wherein the lock price includes a markup.

9. A system for providing price protection for commodity purchasing, comprising:
one or more computer devices; and
a price protection system coupled to the one or more computing devices such that a consumer at a computer device may access the hedge system, the price protection system operable for:
obtaining data regarding desired price protection from a consumer; and
providing a financial instrument for a commodity to the consumer where the financial instrument has an associated quantity, time period, lock price and locale wherein for a set of purchases occurring in the locale during the time period the consumer has a right to aggregately purchase the quantity of the commodity wherein for each purchase the commodity may be purchased at the lock price if a first index price associated with the commodity at a first time of the purchase is above the lock price or at a retail price of the commodity otherwise.

10. The system of claim 9, wherein if the index price is greater than the lock price and the retail price is greater than the first index price the consumer pays the difference between the lock price and the retail price.

11. The system of claim 9, wherein if the first index price is greater than the lock price and the retail price is less than the first index price the consumer receives at a least a portion of a spread between the retail price and the first index price.

12. The system of claim 9, wherein the first index price corresponds to the locale.

13. The system of claim 12, wherein the price protection system is operable to determine the lock price.

14. The system of claim 13, wherein determining the lock price comprises determining a second index price associated with the locale at a second time when the financial instrument is provided and using the second index price to determine the second index price.

15. The system of claim 14, wherein determining the lock price comprises:
receiving an insurance strike price matrix; and
determining the lock price based on the insurance strike price matrix, the locale, the time period and the fuel grade.

16. The system of claim 15, wherein the lock price includes a markup.

17. A computer readable media for providing price protection for commodity purchasing comprising instructions executable for:
obtaining data regarding desired price protection from a consumer; and
providing a financial instrument for a commodity to the consumer where the financial instrument has an associated quantity, time period, lock price and locale wherein for a set of purchases occurring in the locale during the time period the consumer has a right to aggregately purchase the quantity of the commodity wherein for each purchase the commodity may be purchased at the lock price if a first index price associated with the commodity at a first time of the purchase is above the lock price or at a retail price of the commodity otherwise.

18. The computer readable media of claim 17, wherein if the index price is greater than the lock price and the retail price is greater than the first index price the consumer pays the difference between the lock price and the retail price.

19. The computer readable media of claim 17, wherein if the first index price is greater than the lock price and the retail price is less than the first index price the consumer receives at a least a portion of a spread between the retail price and the first index price.

20. The computer readable media of claim 17, wherein the first index price corresponds to the locale.

21. The computer readable media of claim 20, wherein the instructions are further executable for determining the lock price.

22. The computer readable media of claim 21, wherein determining the lock price comprises determining a second index price associated with the locale at a second time when the financial instrument is provided and using the second index price to determine the second index price.

23. The computer readable media of claim 21, wherein determining the lock price comprises:
receiving an insurance strike price matrix; and
determining the lock price based on the insurance strike price matrix, the locale, the time period and the fuel grade.

24. The computer readable media of claim 23, wherein the lock price includes a markup.
